(19) United States
(12) Patent Application Publication
(10) Pub. No.: US 2011/0252301 A1
(43) Pub. Date: Oct. 13, 2011

(54) HISTORY VIEW, A GRAPHICAL USER INTERFACE FOR A HISTORY VIEW, AND A SYSTEM ENABLING A HISTORY VIEW

(75) Inventors: Till Vollmer, Munich (DE); Michael Hollauf, Vienna (AT)

(73) Assignee: MEISTERLABS GMBH, Munchen (DE)

(21) Appl. No.: 12/906,233

(22) Filed: Oct. 18, 2010

Related U.S. Application Data
(60) Provisional application No. 61/252,729, filed on Oct. 19, 2009.

(51) Int. Cl. G06F 17/00

(52) U.S. Cl. 715/229

(57) ABSTRACT

A method of displaying an electronic document including versions is provided. The versions include a current version and at least one prior version. The method includes providing a movable slider including markers. Each marker corresponds to one of the versions of the document. The method also includes providing a pointer adapted to indicate one of the markers, and displaying one of the versions of the document when the pointer indicates a corresponding one of the markers. A graphical user interface is provided that includes a preview area for displaying an electronic document. The graphical user interface also includes a movable slider including markers corresponding to one of the versions of the document, and a pointer for indicating one of the markers. The preview area displays one of the versions of the document when the pointer indicates a corresponding one of the markers. A computer-readable medium is provided.

### CROSS-REFERENCE TO RELATED APPLICATIONS

This application claims the benefit of U.S. Provisional Application No. 61/252,729 filed Oct. 19, 2009, which is incorporated herein by reference.

### BACKGROUND OF THE INVENTION

1. Field of the Invention

The present invention relates to software applications. In particular, the present invention relates to a history view in a software application, a graphical user interface for a history view, and a system for enabling history view in a software application.

2. Description of Prior Art

Computer programs may have an “undo” function that enables a user to reverse a change and/or revert to a previous version of a document. Some computer programs may only undo one change (which may be defined as an act caused by a single keystroke or input, or a set of grouped inputs), while some programs may keep track of a history of changes. In programs storing a history of changes, a user may be able to undo a last change, and also may be able to go back a few steps sequentially in the revisions to the document, namely to a previous version. In this manner, a user may be able to correct possible errors introduced in the editing or revising of a document, even after intervening changes have been made. Adobe Photoshop™ has a version history for single users, which allows a user to undo multiple steps.

In some networking environments, multiple users may work together on a project that might be embodied in, or include, an electronic document. This project might be a single document of any form, for instant a drawing, an image and texts, or complex structures like a project, source code or a music tune.

Keeping track of changes in a multi-user environment may be accomplished using a version control system, which may run on a server and track the different changes (also referred to as commits) of the various users/people. Some exemplary revision systems are Subversion, CVS, GIT and Perforce™. Using version history, it may be possible to view changes to text documents, usually through a “difference” view that shows the differences from one version to another. While this approach may be suitable to identify differences between two versions, there is no big picture view to see how a document evolved through time. Conventional revisions systems may only handle text files and may not show differences in a graphical manner.

When multiple people collaborate on a single graphical document, they may want to see how the document has evolved over time, and may also want to identify who did what kind of changes to the document.

Traceability of changes is becoming more important for compliance reasons. For example, investigators or forensic experts may want to identify the person and date of a change in a corporate document, a legal document, an engineering document, architectural plans, or any other type of document.

### BRIEF SUMMARY OF THE INVENTION

One aspect of the invention allows a user to view a set of changes of a document in a preview area instead of only showing the difference between two versions. In further embodiments, an optional color-coding of the changed content allows viewers to easily identify which person did which changes to a document.

Exemplary embodiments provide a history view for graphical documents that can be replayed live to see the document's evolution over time, and to optionally revert the document to a previous stage or copy a previous stage of the document.

A system for displaying and accessing changes to a document is provided. The system includes a display adapted to show changes made in a history view that is adapted to replay all changes in a preview area. The user can select certain changes and display the document in that state. The system may identify which changes were done by which person using color coding of the elements in the preview area. The user may use the history view to move through the changes, in either a forward or reverse chronological direction, and see immediately who applied the changes and what element was affected. The system may include a data storage element storing the document and a history of the revisions.

A method of showing a history of changes to a document is provided. The method includes displaying the document. The method allows easy browsing through the changes (through slider and playback controls) and identifies the user that did a particular change in textual form, and optionally through color coding of the elements. The method may include displaying a graphical representation of the document that was created by users in a collaborative environment. The method may include storing the document and its associated version history.

The system and method may be used for documents such as mind maps, images, engineering plans, CAD images, or any other appropriate document.

### BRIEF DESCRIPTION OF THE DRAWINGS

FIG. 1 illustrates an exemplary graphical user interface with a history view of an image in the preview area;

FIG. 2 illustrates an exemplary graphical user interface with a history view of a mind map in the preview area;

FIG. 3 illustrates a system according to an exemplary embodiment;

FIG. 4 illustrates a method according to an exemplary embodiment; and

FIG. 5 illustrates a computer system according to an exemplary embodiment.

### DETAILED DESCRIPTION OF THE INVENTION

The present invention relates to providing a graphical representation of a series of changes done by several different individual over a network and, in particular, a system for accessing, viewing and displaying the changes done to documents in a way that improves traceability.

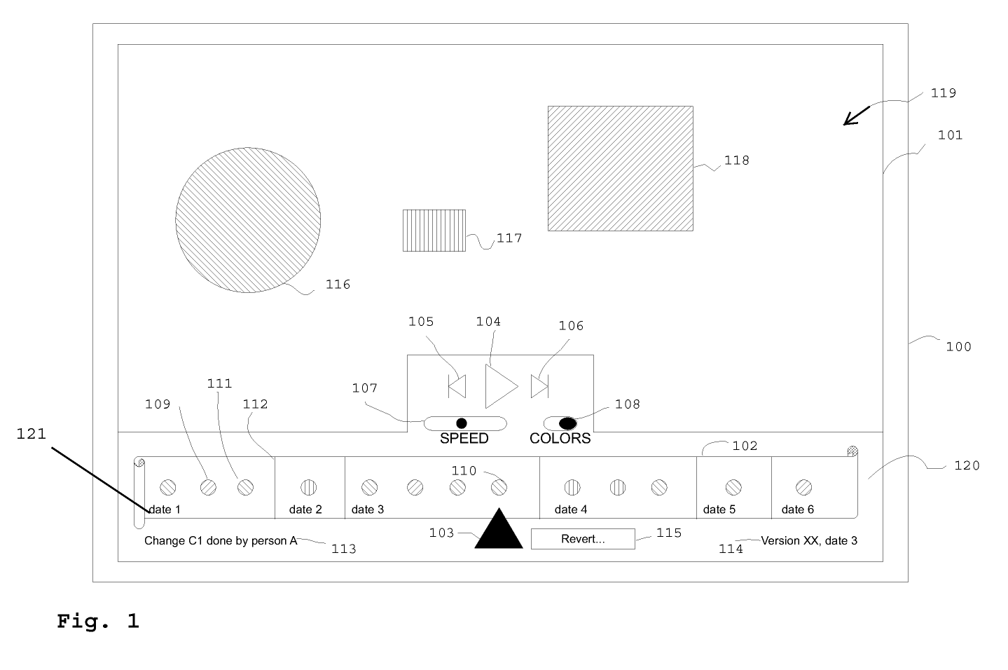

FIG. 1 illustrates an exemplary graphical user interface including display window 100 including preview area 101 and slider area 120. Preview area 101 displays the content of image 119. Image 119 may include an image created by a paint application. Alternatively, any other textual or graphical document can be used in a history view according to the present innovation.

Slider area 120 includes slider 102, which in turn includes markers 109, 111 and currently viewed version marker 110 (also referred to as icons), and pointer 103 (also referred to as an arrow) that indicates currently viewed version marker 110. Slider 102 also includes date 121 and date line 112. Slider area 120 also includes change view 113, version view 114, and action button 115. Change view 113 provides a textual description of the change made to an immediately previous version of the document or image to arrive at the version of the document corresponding to currently viewed version marker 110. Version view 114 provides a version indicator, for instance including a version number and a modification date for current viewed version 110. Action button 115 enables actions to be performed on currently viewed version marker 110, including for example, reverting the document or image to currently viewed version marker 110, or copying currently viewed version marker 110 and creating a new file or placing it in an electronic clipboard. Alternatively or additionally, action button 115 may enable emailing of currently viewed version marker 110. Action button 115 may be presented as a drop down menu or by any other appropriate display and selection technique.

Above slider 102 are playback button 104, go-to-first-change button 105, and go-to-last-change button 106. Also arranged in this area are color enabling switch 108 and speed slider 107. These activatable buttons and sliders, as well as the operation of the previously discussed elements, are explained in further detail in the following description of a user interacting with an exemplary embodiment of the innovation.

When a user enters the history view to browse through the changes, the history view retrieves all changes and shows the last state (also referred to as the current document or the latest version) in preview area 101. In this case, the document is image 119 including image objects 116, 117, 118 (also referred to as graphical objects, graphics, and objects).

The history view shows each change made to the document as a different marker in slider 102. Each change is represented by a marker (here represented as circles), for instance markers 109, 110, 111. Each marker is colored based on the person that made the change to the immediately previous version of the document to create the version of the document represented by the particular marker. The different colors of the markers are shown in the drawing by differently oriented striped filling. The changes may be grouped by date, for instance date 121, which may be written on slider 102, and separated by date lines, for instance date line 112. Alternative time periods may be delineated on the slider to promote usability, for instance when a document is revised only infrequently (which may give rise to month lines or year lines), or very frequently (which may give rise to hour lines or minute lines).

Changes to a document may be singular or groups of changes that are logically associated. For instance, editing the document to move an object from a first position to a second position, and then immediately moving the object to a third position, may be defined as a single change of moving the object to the third position. Likewise, adding text of a word or sentence may be defined as a single change, rather than each additional letter defining a new change. Alternatively, each keystroke, mouse click, or other input made by a user (also referred to as an editor or collaborator) may give rise to a new change, and therefore a new marker identifying the keystroke or other input.

Pointer 103 points to currently viewed version marker 110 that corresponds to image 119 shown in preview area 101. A user can drag slider 102 to the left or right by selecting any portion of slider 102 (by, for instance, positioning a cursor over slider 102 and activating a mouse button) and moving the mouse or pressing an arrow, causing another marker or icon to be selected by pointer 103. In this manner, the user can review the history of the document. Optionally or alternatively, the user can click on a specific marker identifying a specific change, for example marker 109. In this case, slider 102 will scroll in response to the selecting of the specified marker to that marker, causing the corresponding version to be displayed in preview area 101.

Additionally, a user can play the changes occurring in the document starting with the version shown in preview area 101 and associated with currently viewed version marker 110 selected by pointer 103. To do so, the user presses play button 104, which causes the slider 102 to start moving to the left, thereby showing subsequent changes. Pointer 103 remains stationary and always indicates a marker corresponding to the version of the document displayed in preview area 101 while slider 102 moves.

Go-to-first-change button 105 jumps slider 102 to the start of the changes where the document was created. Go-to-last-change button 106 jumps to the last actual version, also referred to as the current version, of the document. The playback speed can be adjusted by speed slider 107.

When a user plays back a history of a document using play button 104, or when a specific version is selected by clicking on a marker or dragging slider 102, preview area 101 shows the version of the document corresponding to the marker selected by pointer 103. Image objects 116, 117, 118 in preview area 101 appear in the same state they appeared when the document was edited, and may appear without any additional information. If optional color coding is enabled through switch 108, then the elements (e.g. image objects 116, 117, 118) are also marked with colors (in FIG. 1 shown by dashed filling styles). The color identifies the user that made the last change to this element prior to the version being displayed. The color of image objects 116, 117, 118 identifies the person, by a marker color, who did the corresponding changes. For instance, in FIG. 1, which uses differently oriented striped lines instead of colors, the user identified as making the change indicated by marker 109 also made the last change to image object 118 prior to the version of the document corresponding to currently viewed version marker 110. Likewise, the user identified as making the change indicated by markers 110 and 111 also made the last change to image object 116 prior to the version of the document corresponding to currently viewed version marker 110.

Change view 113 describes the last change made to the version of the document corresponding to currently viewed version marker 110 indicated by pointer 103. For example, if a user A has moved circle 116 in the version of the document corresponding to currently viewed version marker 110, change view 113 may state: “Moved circle from coordinate x to coordinate y by user A”. FIG. 1 recites a generic change in change view 113, specifically: “Change C1 done by person A”. Version view 114 shows a version number of the current change and the date and time the change was made to create the version of the document corresponding to currently viewed version marker 110. Alternatively, other information identifying the version may be shown in version view 114.

Additionally or alternatively, action button 115 may be present allowing manipulation of the current selected version. Actions enabled by action button 115 may be either copying of the current version or reverting the document to the current version. Other actions may be also possible depending on the context of the history view. Action button 115 may be a single function button, a drop down menu presenting several options, or may be any other appropriate method of providing options to a user.

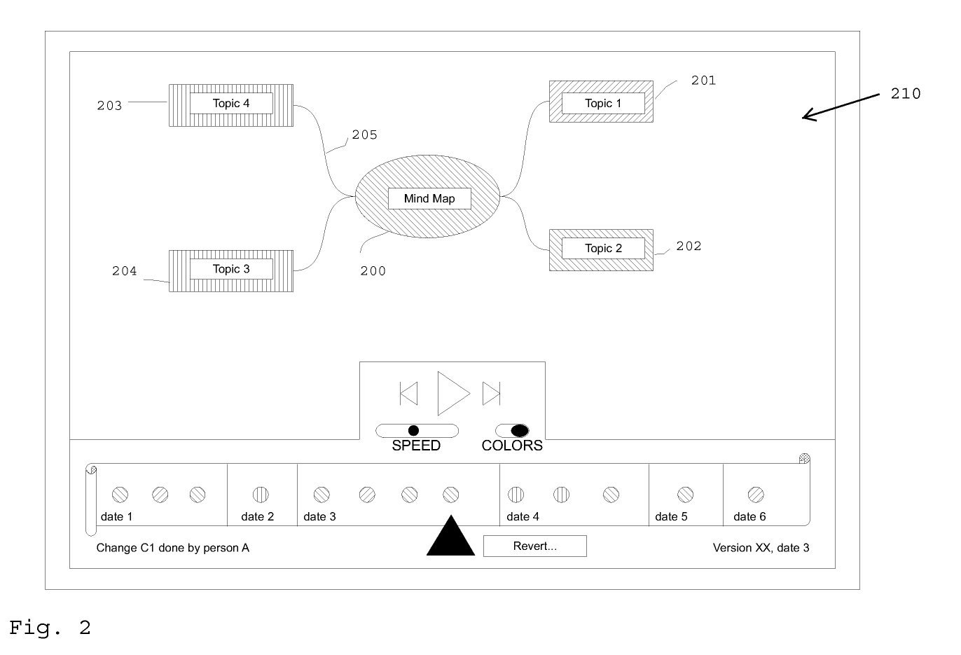

The invention supports different document types. The paint image of FIG. 1 is shown for illustration purposes, and any other document type such as text or a mind map can be used. For example, FIG. 2 shows the history view of a mind mapping application. Mind map 210 appears in a preview area, and includes elements 200, 201, 202, 203 and 204. Elements 200, 201, 202, 203 and 204 are color coded with the color of the user who last changed this specific element. Connection 205 indicates a relationship between elements 203 and 200, and may also be color coded if necessary and/or desired. The color coding of elements 200, 201, 202, 203 and 204, and/or connection 205, may be for all situations or only when a color enabling switch is enabled. The slider area and the tools shown in FIG. 2 may provide a history view in the same manner as discussed above in regard to FIG. 1.

A graphical user interface is provided that includes a preview area adapted to display an electronic document. The document includes versions and the versions include a current version and at least one prior version. The graphical user interface also includes a movable slider including markers, each marker corresponding to one of the versions of the document, and a pointer adapted to indicate one of the markers. The preview area displays one of the versions of the document when the pointer indicates a corresponding one of the markers.

In the graphical user interface, the slider may be activatable by selecting and dragging, and dragging the slider may cause the pointer to indicate another marker.

The graphical user interface may include a play button activatable to sequentially move the slider with respect to the pointer causing the pointer to sequentially indicate a plurality of the markers and causing a plurality of the versions of the document to be displayed in the preview area when the pointer indicates the corresponding marker.

The graphical user interface may include a speed selector for receiving an input indicating a rate of speed for sequentially moving the slider with respect to the pointer when the play button is activated.

The graphical user interface may include a first change button activatable to move the slider with respect to the pointer causing the pointer to indicate a first marker and causing a first prior version of the document corresponding to the document prior to a first change to be displayed. The graphical user interface may also include a last change button activatable to move the slider with respect to the pointer causing the pointer to indicate a last marker and causing the current version of the document to be displayed.

In the graphical user interface, the markers may have associated colors, with each color corresponding to one of a plurality of users capable of changing the document. The corresponding one of the markers indicated by the pointer may be a particular one of the colors corresponding to a particular user that made a change to an immediately previous one of the versions of the document to create the version of the document being displayed.

The graphical user interface may include providing a color switch activatable to display each element of the version of the document being displayed in the color corresponding to a respective one of the users that last changed the particular element. The color switch may be deactivatable to cause the elements to be displayed monochromatically or in a same color.

The graphical user interface may include a description box including a textual description of a change made to an immediately previous one of the versions of the document to create the version of the document being displayed. The graphical user interface may also include a version identifier identifying the version of the document being displayed.

The graphical user interface may include an action button activatable to revert the document to the version being displayed, copy the version being displayed into a new document, make a first list of all changes made to the document from a first prior version up to the version being displayed, and/or make a second list of all changes made to the document from the first prior version up to the current version.

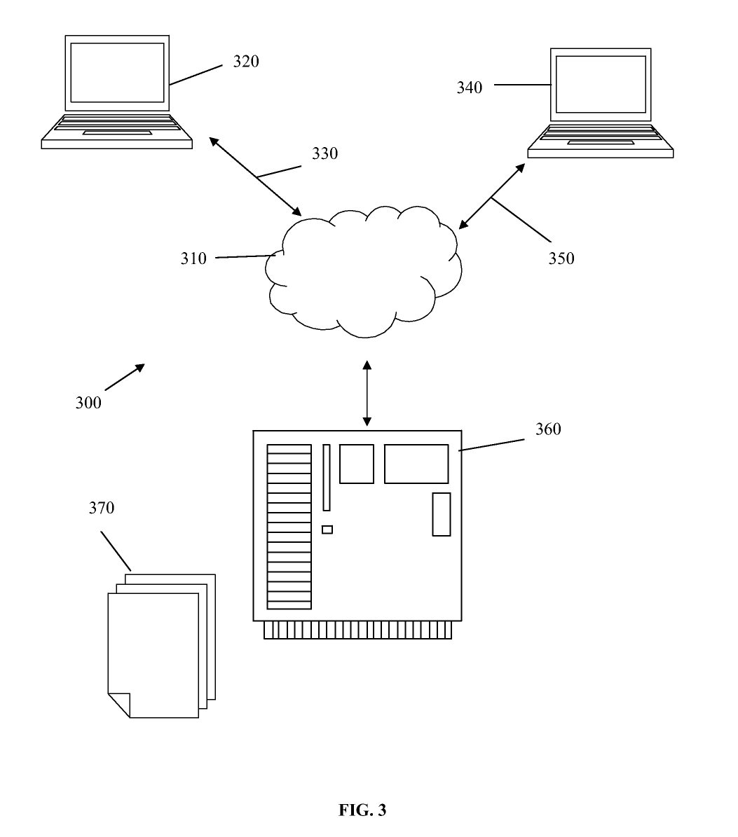

FIG. 3 is a schematic view of a system to display and access changes to documents that are stored in a revision system. The changes are shown in a history view that can replay all changes in a preview area and enables the user to select certain changes and display the document in that state. To identify which changes were done by which person, color coding of the elements in the preview area may be applied. The user of the history view can easily travel through the changes back and forth and immediately identify who applied the changes and what element was affected.

FIG. 3 shows history view system 300 which includes terminals 320 and 340 using communication links 330 and 350, respectively, to connect to network 310. Alternatively, only one terminal may be used in history view system 100, and may be a personal computer, notebook computer, netbook, smartphone, or any other appropriate device. Network 310 may be an internal network, a wireless network, an intranet, and/or the internet. Server 360 may be in communication with network 310, and may include one or more servers or personal computers operating as a server. Server 360 may include a database or alternatively may access a database, and may access records 370. Records 370 may include electronic documents and revision information, including user identification, dates, and change identifications.

An exemplary embodiment of the present innovation may operate in a physical and/or a virtual environment, which may consist of various parts. For instance, the environment may include a computer system that allows several people to work on one specific document over a network or shared computer environment. This may include a client server infrastructure or a web server with a web browser as client.

Additionally, the environment may include a revision system that manages documents, and tracks and retains the changes done to the documents. This may include a component on the web server that keeps track of all changes. The environment may include an application programming interface (API) to access the revision system through the network, and to submit changes and retrieve all necessary information to create a version history.

The exemplary innovation includes a method to show the history of changes of a graphical representation (e.g. mind map, image, engineering plan, etc.) that was created by people through collaboration. The method allows easy browsing through the changes (through slider and playback controls) and shows who did which changes in textual form and optionally through color coding of the elements.

A method of displaying an electronic document including versions is provided. The versions include a current version and at least one prior version. The method includes providing a movable slider including markers. Each marker corresponds to one of the versions of the document. The method also includes providing a pointer adapted to indicate one of the markers, and displaying one of the versions of the document when the pointer indicates a corresponding one of the markers.

In the method, the slider may be activatable by selecting and dragging, and dragging the slider may cause the pointer to indicate another marker.

The method may include providing a play button activatable to sequentially move the slider with respect to the pointer causing the pointer to sequentially indicate a plurality of the markers and causing a plurality of the versions of the document to be displayed when the pointer indicates the corresponding marker.

The method may include providing a speed selector for receiving an input indicating a rate of speed for sequentially moving the slider with respect to the pointer when the play button is activated.

The method may include providing a first change button activatable to move the slider with respect to the pointer causing the pointer to indicate a first marker and causing a first prior version of the document corresponding to the document prior to a first change to be displayed. The method may also include providing a last change button activatable to move the slider with respect to the pointer causing the pointer to indicate a last marker and causing the current version of the document to be displayed.

In the method, the markers may have associated colors, each color corresponding to one of a plurality of users capable of changing the document. The corresponding one of the markers indicated by the pointer may be a particular one of the colors corresponding to a particular user that made a change to an immediately previous one of the versions of the document to create the version of the document being displayed.

The method may include providing a color switch activatable to display each element of the version of the document being displayed in the color corresponding to a respective one of the users that last changed the particular element. The color switch may be deactivatable to cause the elements to be displayed monochromatically or in a same color.

The method may include providing a description box including a textual description of a change made to an immediately previous one of the versions of the document to create the version of the document being displayed. The method may also include providing a version identifier identifying the version of the document being displayed.

The method may include providing an action button activatable to revert the document to the version being displayed, copy the version being displayed into a new document, make a first list of all changes made to the document from a first prior version up to the version being displayed, and/or make a second list of all changes made to the document from the first prior version up to the current version.

In the method, the document may be a mind map, a collaborative project, an engineering plan, a CAD image, a textual document, an architecture plan and/or a visual image.

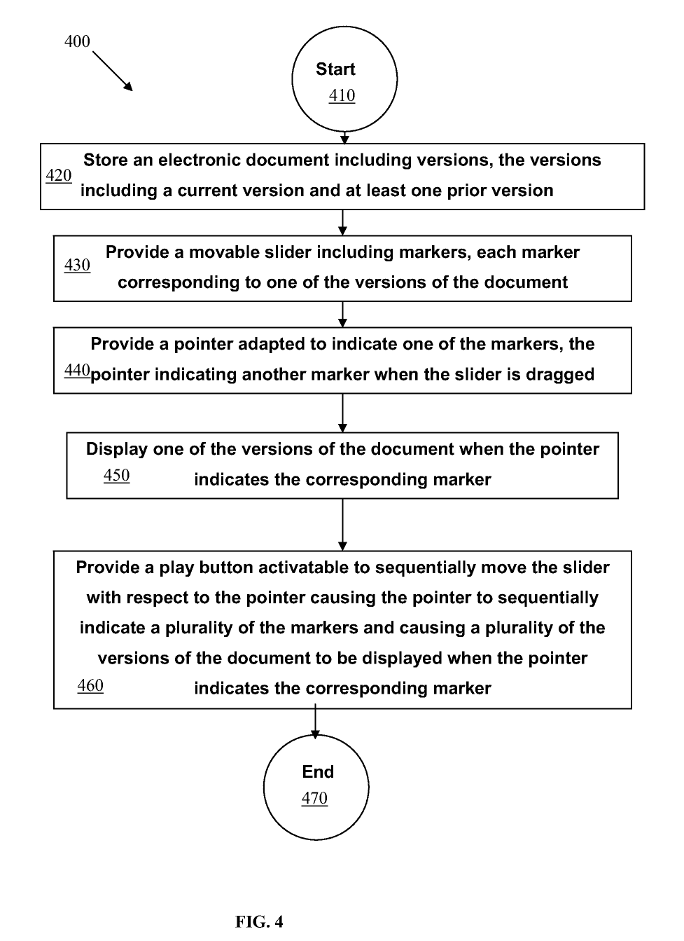

FIG. 4 illustrates method 400 according to an exemplary embodiment. Method 400 starts at start circle 410 and proceeds to operation 420, which indicates to store an electronic document including versions. The versions include a current version and at least one prior version. From operation 420 the flow in method 400 proceeds to operation 430, which indicates to provide a movable slider including markers. Each marker corresponds to one of the versions of the document. From operation 430 the flow in method 400 proceeds to operation 440, which indicates to provide a pointer adapted to indicate one of the markers. The pointer indicates another marker when the slider is dragged. From operation 440 the flow in method 400 proceeds to operation 450, which indicates to display one of the versions of the document when the pointer indicates the corresponding marker. From operation 450 the flow in method 400 proceeds to operation 460, which indicates to provide a play button activatable to sequentially move the slider with respect to the pointer causing the pointer to sequentially indicate a plurality of the markers and causing a plurality of the versions of the document to be displayed when the pointer indicates the corresponding marker. From operation 460 the flow in method 400 proceeds to end circle 470.

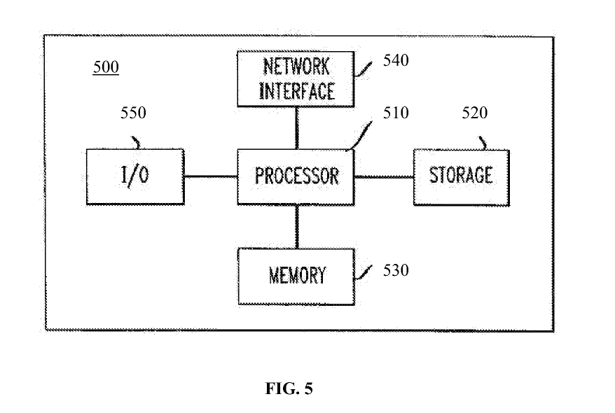

FIG. 5 illustrates a computer system according to an exemplary embodiment. Computer 500 can, for example, drive display window 100, store the images and versions displayed in preview area 101, or be any of terminals 320, 340 and server 360. Additionally, computer 500 can perform the steps described above (e.g., with respect to FIG. 4). Computer 500 contains processor 510 which controls the operation of computer 500 by executing computer program instructions which define such operation, and which may be stored on a computer-readable recording medium. The computer program instructions may be stored in storage 520 (e.g., a magnetic disk, a database) and loaded into memory 530 when execution of the computer program instructions is desired. Thus, the computer operation will be defined by computer program instructions stored in memory 530 and/or storage 520 and computer 500 will be controlled by processor 510 executing the computer program instructions. Computer 500 also includes one or more network interfaces 540 for communicating with other devices, for example other computers, servers, or websites. Network interface 540 may, for example, be a local network, a wireless network, an intranet, or the Internet. Computer 500 also includes input/output 550, which represents devices which allow for user interaction with the computer 500 (e.g., display, keyboard, mouse, speakers, buttons, webcams, etc.). One skilled in the art will recognize that an implementation of an actual computer will contain other components as well, and that FIG. 5 is a high level representation of some of the components of such a computer for illustrative purposes.

A computer-readable medium is provided having stored thereon computer-executable instructions. The computer-executable instructions cause a processor to perform a method when executed. The method is for displaying an electronic document including versions. The versions include a current version and at least one prior version. The method includes providing a movable slider including markers, each marker corresponding to one of the versions of the document, the slider being activatable by selecting and dragging. The method also includes providing a pointer adapted to indicate one of the markers, the pointer indicating another marker when the slider is dragged. The method further includes displaying one of the versions of the document when the pointer indicates a corresponding one of the markers, and providing a play button activatable to sequentially move the slider with respect to the pointer causing the pointer to sequentially indicate a plurality of the markers and causing a plurality of the versions of the document to be displayed when the pointer indicates the corresponding marker. The method also includes providing a speed selector for receiving an input indicating a rate of speed for sequentially moving the slider with respect to the pointer when the play button is activated.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

We claim:

1. A method of displaying an electronic document comprising versions, the versions comprising a current version and at least one prior version, comprising:
providing a movable slider comprising markers, each marker corresponding to one of the versions of the document;
providing a pointer adapted to indicate one of the markers; and
displaying one of the versions of the document when the pointer indicates a corresponding one of the markers.

2. The method of claim 1, wherein:
the slider is activatable by selecting and dragging; and
dragging the slider causes the pointer to indicate another marker.

3. The method of claim 1, further comprising providing a play button activatable to sequentially move the slider with respect to the pointer causing the pointer to sequentially indicate a plurality of the markers and causing a plurality of the versions of the document to be displayed when the pointer indicates the corresponding marker.

4. The method of claim 3, further comprising providing a speed selector for receiving an input indicating a rate of speed for sequentially moving the slider with respect to the pointer when the play button is activated.

5. The method of claim 3, further comprising:
providing a first change button activatable to move the slider with respect to the pointer causing the pointer to indicate a first marker and causing a first prior version of the document corresponding to the document prior to a first change to be displayed; and
providing a last change button activatable to move the slider with respect to the pointer causing the pointer to indicate a last marker and causing the current version of the document to be displayed.

6. The method of claim 1, wherein the markers have associated colors, each color corresponding to one of a plurality of users capable of changing the document, the corresponding one of the markers indicated by the pointer being a particular one of the colors corresponding to a particular user that made a change to an immediately previous one of the versions of the document to create the version of the document being displayed.

7. The method of claim 6, further comprising providing a color switch activatable to display each element of the version of the document being displayed in the color corresponding to a respective one of the users that last changed the particular element, the color switch being deactivatable to cause the elements to be displayed monochromatically or in a same color.

8. The method of claim 1, further comprising:
providing a description box comprising a textual description of a change made to an immediately previous one of the versions of the document to create the version of the document being displayed; and
providing a version identifier identifying the version of the document being displayed.

9. The method of claim 1, further comprising providing an action button activatable to at least one of:
revert the document to the version being displayed;
copy the version being displayed into a new document;
make a first list of all changes made to the document from a first prior version up to the version being displayed; and
make a second list of all changes made to the document from the first prior version up to the current version.

10. The method of claim 1, wherein the document is at least one of a mind map, a collaborative project, an engineering plan, a CAD image, a textual document, an architecture plan and a visual image.

11. A graphical user interface comprising:
a preview area adapted to display an electronic document, the document comprising versions and the versions comprising a current version and at least one prior version;
a movable slider comprising markers, each marker corresponding to one of the versions of the document; and
a pointer adapted to indicate one of the markers, the preview area displaying one of the versions of the document when the pointer indicates a corresponding one of the markers.

12. The graphical user interface of claim 11, wherein:
the slider is activatable by selecting and dragging, and
dragging the slider causes the pointer to indicate another marker.

13. The graphical user interface of claim 11, further comprising a play button activatable to sequentially move the slider with respect to the pointer causing the pointer to sequentially indicate a plurality of the markers and causing a plurality of the versions of the document to be displayed in the preview area when the pointer indicates the corresponding marker.

14. The graphical user interface of claim 13, further comprising a speed selector for receiving an input indicating a rate of speed for sequentially moving the slider with respect to the pointer when the play button is activated.

15. The graphical user interface of claim 13, further comprising:
a first change button activatable to move the slider with respect to the pointer causing the pointer to indicate a first marker and causing a first prior version of the document corresponding to the document prior to a first change to be displayed; and
a last change button activatable to move the slider with respect to the pointer causing the pointer to indicate a last marker and causing the current version of the document to be displayed.

16. The graphical user interface of claim 11, wherein the markers have associated colors, each color corresponding to one of a plurality of users capable of changing the document, the corresponding one of the markers indicated by the pointer being a particular one of the colors corresponding to a particular user that made a change to an immediately previous one of the versions of the document to create the version of the document being displayed.

17. The graphical user interface of claim 16, further comprising providing a color switch activatable to display each element of the version of the document being displayed in the color corresponding to a respective one of the users that last changed the particular element, the color switch being deactivatable to cause the elements to be displayed monochromatically or in a same color.

18. The graphical user interface of claim 11, further comprising:
a description box comprising a textual description of a change made to an immediately previous one of the versions of the document to create the version of the document being displayed; and
a version identifier identifying the version of the document being displayed.

19. The graphical user interface of claim 11, further comprising an action button activatable to at least one of:
revert the document to the version being displayed;
copy the version being displayed into a new document;
make a first list of all changes made to the document from a first prior version up to the version being displayed; and
make a second list of all changes made to the document from the first prior version up to the current version.

20. A computer-readable medium having stored thereon computer-executable instructions, the computer-executable instructions causing a processor to perform a method when executed, the method for displaying an electronic document comprising versions, the versions comprising a current version and at least one prior version, the method comprising:
providing a movable slider comprising markers, each marker corresponding to one of the versions of the document, the slider being activatable by selecting and dragging;
providing a pointer adapted to indicate one of the markers, the pointer indicating another marker when the slider is dragged;
displaying one of the versions of the document when the pointer indicates a corresponding one of the markers;
providing a play button activatable to sequentially move the slider with respect to the pointer causing the pointer to sequentially indicate a plurality of the markers and causing a plurality of the versions of the document to be displayed when the pointer indicates the corresponding marker; and
providing a speed selector for receiving an input indicating a rate of speed for sequentially moving the slider with respect to the pointer when the play button is activated.
